(19) United States
(12) Patent Application Publication
(10) Pub. No.: US 2009/0243276 A1
(43) Pub. Date: Oct. 1, 2009

(54) Document Cover

(76) Inventor: Chun-Lung Yang, Niaosong Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/056,351

(22) Filed: Mar. 27, 2008

(51) Int. Cl. B42D 3/00

(52) U.S. Cl. 281/29

(57) ABSTRACT

A stapling cover comprises a connecting portion, a bent portion and a front cover portion, with the connecting portion, the bent portion and the front cover portion being integrally formed. The connecting portion has an adhesive layer on one surface thereof. The bent portion having a plurality of creases parallel to each other connects one side of the connecting portion. The front cover portion connects another side of the bent portion opposite to the connecting portion. A stack of papers is bound in the document cover, with the bent portion attaching to one side of the stack of papers and the connecting portion adhering to a rear cover panel, so that convenience of binding a stack of papers with a document cover is enhanced.

### BACKGROUND OF THE INVENTION

1. Field of the Invention

The present invention relates to a document cover, especially relating to a document cover stapled to a stack of papers.

2. Description of the Related Art

A conventional document cover comprises an adhesive and a cover panel. The adhesive is applied to one edge of a stack of papers and the cover panel is adhered to the stack of papers by the adhesive while crossing the edge and covering two opposite surfaces of the stack of papers. When using the conventional document cover to bind the stack of papers, the adhesive is previously heated to melt for applying to the side edge of the stack of papers, so as to glue the cover panel and the stack of papers together. However, for tight adhesion, pressing the cover toward the edge of the stack of papers may result in overflow of the adhesive. Thereby, the size of the cover panel must be a little bigger than that of the stack of papers, so that there is an extra portion of the cover panel and the adhesive to be cut off after cooling and hardening of the adhesive. Nevertheless, the cutting step complicates the assembly process of the document cover and the stack of papers and causes inconvenience of using the document cover.

Another conventional document cover illustrated by FIG. 1 comprises a front cover panel 91, a rear cover panel 92 and a spine cover flap 93. The front cover panel 91 and the rear cover panel 92 cover two opposite surfaces of a stack of papers 94 respectively and are made of pieces of paper or transparencies to provide functions as document protection and identification. Sizes of the front and rear cover panels 91, 92 are the same as those of both the surfaces of the stack of papers 94. The spine cover flap 93 has an adhesive on one surface thereof to adhere to a side of the stack of papers 94, which lays between said two surfaces. Besides, the edges of the adhesive of the spin cover flap 93 can also adhere to the front and rear cover panels 91, 92.

For stapling the stack of papers 94 with this conventional document cover, the front and rear cover panel 91, 92 previously printed are attached to said two opposite surfaces of the stack of papers 94. And then the two cover panels 91, 92 and the stack of papers 94 are fastened with staples arranged along said side of the stack of papers 94 and on the front and rear cover panels 91, 92. Afterwards, the spin cover flap 93 is adhered to said side of the stack of papers 94, and two opposite sides of the spin cover flap 93 are bent to adhere to the front and rear cover panels 91, 92 respectively. Nevertheless, said conventional document cover has several drawbacks. For example, the spin cover flap 93 independent to the front or rear cover panel 91, 92 results in inconvenience of precise positioning between the spine cover flap 93 and the stack of papers 94. Otherwise, improper length of the spin cover flap 93 may also induce a misalignment between edges of the spin cover flap 93 and the front and rear cover panels 91, 92. Hence, there is a need for an improvement over the conventional document covers.

### SUMMARY OF THE INVENTION

The primary objective of this invention is to provide a document cover, which comprises a connecting portion, a bent portion and a front cover portion that are integrally formed to improve the convenience of stapling a stack of papers with the document cover.

The secondary objective of this invention is to provide the document cover, with the front cover portion having at least one line for a plurality of fasteners to line thereon. Accordingly, the document cover fastened to the stack of papers is beautified.

The document cover in accordance with an aspect of the present invention includes a connecting portion, a bent portion and a front cover portion, with the connecting portion, the bent portion and the front cover portion being integrally formed. The connecting portion has an adhesive layer on one surface thereof. The bent portion having a plurality of creases parallel to each other connects one side of the connecting portion. The front cover portion connects another side of the bent portion opposite to the connecting portion. A stack of papers is bound in the document cover, with the bent portion attaching to one side of the stack of papers and the connecting portion adhering to a rear cover panel, so that convenience of binding a stack of papers with a document cover is enhanced.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view illustrating the document cover in accordance with a conventional invention;

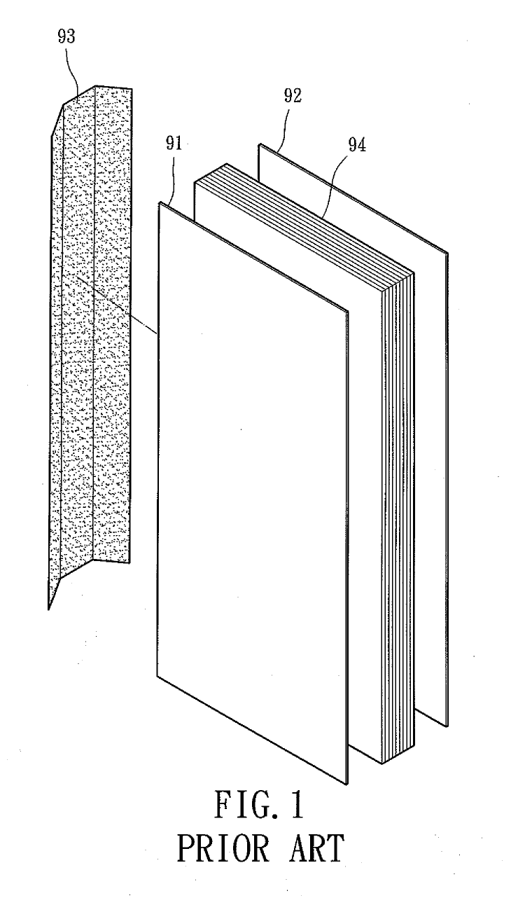

FIG. 2 is an exploded perspective view illustrating the document cover in accordance with a preferable embodiment of the present invention;

FIG. 3 is a perspective view illustrating the document cover in accordance with the preferable embodiment of the present invention during assembly; and

FIG. 4 is a perspective view illustrating the document cover in accordance with the preferable embodiment of the present invention after assembly.

### DETAILED DESCRIPTION OF THE INVENTION

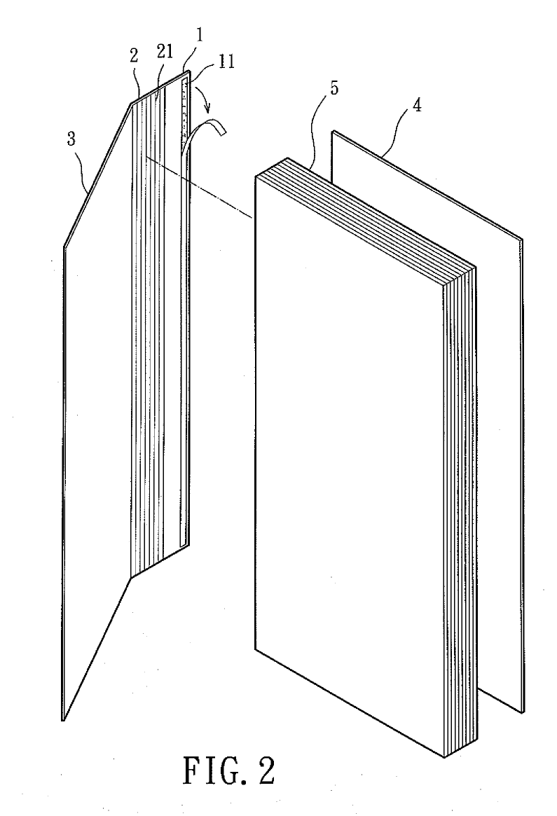

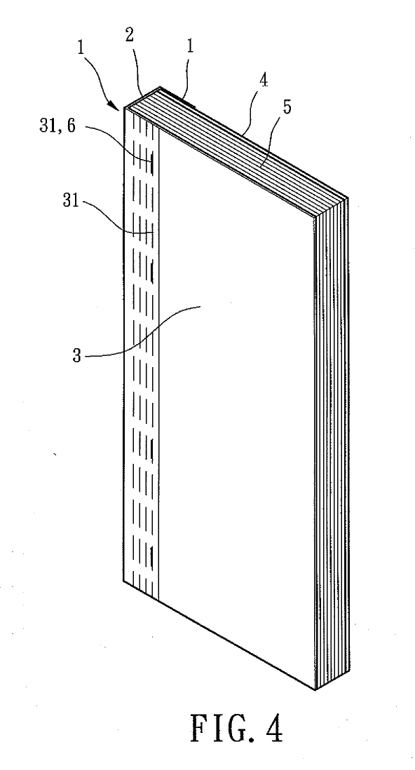

Referring now to FIGS. 2 and 4, a document cover in accordance with a preferable embodiment of the present invention is illustrated. The document cover is made of a piece of paper or a transparency and comprises a connecting portion 1, a bent portion 2 and a front cover portion 3, with the connecting portion 1, the bent portion 2 and the front cover portion 3 being integrally formed. The connecting portion 1 adheres to a rear cover panel 4, with two opposite surfaces of a stack of papers 5 being respectively covered with the rear cover panel 4 and the front cover portion 3 of the document cover. Moreover, one side of the stack of papers 5, which lies between said two opposite surfaces thereof, is covered with the bent portion 2. The document cover is fixed on the stack of papers 5 with a plurality of fasteners 6 that can be selected from staples.

The connecting portion 1 has an adhesive layer 11 on one surface thereof to stick to the rear cover panel 4. The adhesive layer 11 is preferably selected from a double-sided tape.

The bent portion 2 connects to one side of the connecting portion 1 and covers said side of the stack of papers 5. The bent portion 2 has a plurality of creases 21 parallel to each other, so as to be conveniently bent, with the plural creases 21 being utilized for adaptation to various thicknesses of the stacks of papers 5. In the preferable embodiment of the present invention, there are six creases 21 with intervals of 0.1-0.5 cm in between, and intervals with a width of 0.3 cm are preferable. Owing to the pre-formed creases 21 of the bent portion 2, a straight bent line along one of the creases 21 can be rapidly produced. In comparison with the conventional document cover without the creases 21, which may easily lead to a slanting bent line, the present invention using the creases 21 can be easily bent and beautify the appearance of the document cover.

Opposite to the connecting portion 1, the front cover portion 3 connects to another side of the bent portion 2. The size of the front cover portion 3 covering one surface of the stack of papers 5 can be equal to that of the covered surface of the stack of papers 5. Please refer to FIG. 4, one surface of the front cover portion 3, which backs onto the stack of papers 5, has at least one line 31 adjacent to the bent portion 2. The at least one line 31 is printed on the front cover portion 3 previously or is a pre-formed sticker stuck on the front cover portion 3. The color of the at least one line 31 is preferably similar to the staple, a silver line for example, so that the staple can be lined along the at least one line 31 when the document cover is stapled to the stack of papers 5. Furthermore, the staple on the document cover is less apparent after being stapled along the line 31.

The rear cover panel 4 adheres to the connecting portion 1 and covers the other surface of the stack of papers 5 opposite to the surface covered by the front cover portion 3. The size of the rear cover panel 4 is equal to that of the surface of the stack of papers 5 covered by the rear cover panel 4. In general, sizes of two opposite surfaces of a stack of papers are the same, thus the size of the rear cover panel 4 is preferably equal to that of the front cover portion 3.

Moreover, if printing the document cover is necessary, the document cover can be made of a piece of paper or transparency able to be printed by a printer or copier, 150 lb-simili paper for example. For need of printing, the connecting portion 1 and the bent portion 2 are adhered to the surface of the front cover portion 3 that do not have the at least one line 31 and facing the stack of papers 5. In detail, the connecting portion 1 and the bent portion 2 are folded onto and partially and temporarily stuck on the front cover portion 3, so that sizes of the surfaces of the document cover and the stack of papers 5 are the same. Hence, the front cover portion 3 can be printed with the same typesetting for the stack of papers 5. After printing words or patterns, the connecting portion 1 and the bent portion 2 are unfolded for being stapled with the stack of papers 5.

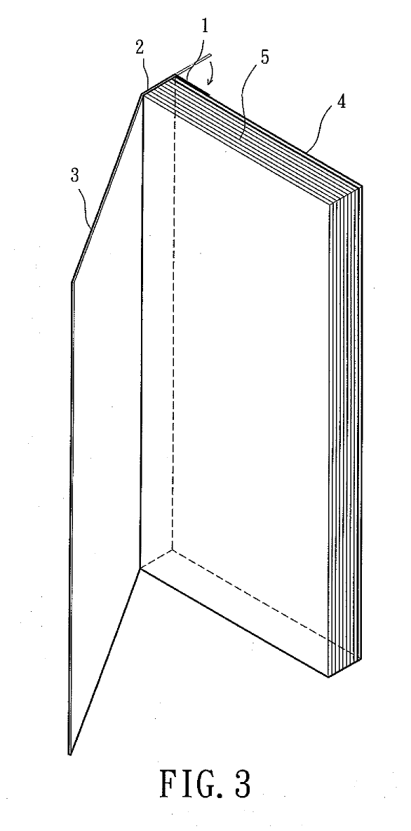

In stapling, referring to FIGS. 3 and 4, the stack of papers 5 and the rear cover panel 4 are put on the front cover portion 3 of the document cover in order, with the front cover portion 3 and the rear cover panel 4 covering said two opposite sides of the stack of papers 5. According to the thickness of the stack of the papers 5, the bent portion 2 is bent along one of the creases 21 to make the connecting portion 1 onto the rear cover panel 4. Then the fasteners 6 were mounted along the at least one line 31 to combine the document cover, the rear cover panel 4 and the stack of papers 5 together. Finally, the adhesive layer 11 of the connecting portion 1 is adhered to the rear cover panel 4. Besides, the document cover also can be made of transparencies or matte films.

As has been discussed above, the present invention provides the document cover being stapled to the stack of papers 5, with the bent portion 2 of the document cover attaching to the side of the stack of papers 5 and the connecting portion 1 of the document cover adhering to the rear cover panel 4. Consequently, the document cover is easy to use in assembling with the stack of paper 5. Moreover, owing to the front cover portion 3 of the document cover being provided with said at least one line 31 for positioning of the fasteners 6, the fasteners 6 mounted on the document cover are less apparently and the appearance of the present invention is beautified.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A document cover, comprising:
a connecting portion having an adhesive layer on one surface thereof;
a bent portion connecting one side of the connecting portion and having a plurality of creases parallel to each other; and
a front cover portion connecting to one side the bent portion opposite to the connecting portion;
wherein the connecting portion, the bent portion and the front cover portion being integrally formed.

2. The document cover as defined in claim 1, wherein one surface of the front cover portion has at least one line adjacent to the bent portion for a plurality of fasteners to line thereon.

3. The document cover as defined in claim 2, wherein color of the line is similar to that of the fasteners.

4. The document cover as defined in claim 1, wherein the connecting portion adheres to a rear cover panel, with the size of the front cover portion equal to that of the rear cover panel.

5. The document cover as defined in claim 1, wherein the connecting portion and the bent portion partially adhere to the front cover portion.

6. The document cover as defined in claim 1, wherein the adhesive layer is a double-sided tape.

7. The document cover as defined in claim 1, wherein an interval between the two adjacent creases is 0.1-0.5 cm.

8. The document cover as defined in claim 7, wherein the interval between the two adjacent creases is 0.3 cm.
